(19) United States
(12) Patent Application Publication
(10) Pub. No.: US 2026/0092865 A1
(43) Pub. Date: Apr. 2, 2026

(54) SYSTEMS AND METHODS FOR MEASURING ELECTRON DENSITY WITHIN A PLASMA

(71) Applicant: REGENTS OF THE UNIVERSITY OF MICHIGAN, Ann Arbor, MI (US)

(72) Inventor: Christopher Limbach, Ann Arbor, MI (US)

(21) Appl. No.: 19/347,426

(22) Filed: Oct. 1, 2025

Related U.S. Application Data
(60) Provisional application No. 63/702,627, filed on Oct. 2, 2024.

(51) Int. Cl. G01N 21/45

(52) U.S. Cl. CPC G01N 21/45; G01N 2201/06113; G01N 2201/08

(57) ABSTRACT

Systems and methods for measuring electron density within a plasma are disclosed herein. An example system includes a laser source configured to emit a light beam, a first second harmonic generation (SHG) component configured to receive the light beam and generate a first harmonic light beam with a first polarization, and a plasma chamber containing a plasma, which the light beam and the first harmonic light beam pass through. The example system further includes a second SHG component configured to receive the light beam after passing through the plasma and generate a second harmonic light beam that has a second polarization. The example system further includes a heterodyne detection component configured to detect an interference pattern of the first harmonic light beam combined with the second harmonic light beam, and data processing circuitry configured to determine an electron density of the plasma based on the interference pattern.

### CROSS-REFERENCE TO RELATED APPLICATION

This application claims priority to U.S. Provisional Patent Application No. 63/702,627, entitled “Systems and Methods for Measuring Electron Density Within A Plasma,” filed on Oct. 2, 2024, the disclosure of which is hereby incorporated herein by reference.

### STATEMENT REGARDING FEDERALLY SPONSORED RESEARCH OR DEVELOPMENT

This invention was made with government support under 80NSSC23PB482 awarded by the National Acronautics and Space Administration. The government has certain rights in the invention.

### TECHNICAL FIELD

The present disclosure generally relates to measuring electron density in plasmas, and more particularly, to leveraging two-color heterodyne interferometer techniques with two second harmonic generation (SHG) components for direct, high-speed electron density measurements.

### BACKGROUND

Plasmas are ionized gases containing a mixture of free-moving ions, electrons, and neutral particles, exhibiting unique properties that are exploited in various fields (e.g., semiconductor manufacturing, materials processing, and propulsion systems). However, in many instances, incorporating plasmas into real-world systems suffers from an inability to measure the plasma characteristics accurately/precisely, such as electron density. Common plasma diagnostic methods, particularly for weakly ionized plasmas, often experience issues with spatial and temporal resolution stemming, in part, from significant background contributions of the neutral gas.

For example, spacecraft atmospheric reentry involves a dynamic plasma environment, where understanding the interaction between the spacecraft and plasma informs the heat shield design and mission success. The high velocity of reentry creates a shock front ahead of the spacecraft, ionizing the atmospheric gases and forming a plasma sheath that significantly affects radiative heat transfer. Current diagnostic techniques typically struggle to provide the necessary spatial and temporal resolution to fully resolve the plasma dynamics in these extreme conditions. Further, many measurement systems are susceptible to environmental factors such as vibrations and electromagnetic interference that further complicate accurate/precise plasma diagnostics.

### SUMMARY

In some aspects, the techniques described herein relate to a system for measuring electron density within a plasma, the system including: a laser source configured to emit a light beam; a first second harmonic generation (SHG) component configured to receive the light beam and generate a first harmonic light beam with a first polarization; a plasma chamber containing a plasma, wherein the light beam and the first harmonic light beam pass through the plasma chamber to shift a phase of the light beam and the first harmonic light beam; a second SHG component configured to receive the light beam after passing through the plasma chamber and generate a second harmonic light beam that has a second polarization; a heterodyne detection component configured to detect an interference pattern of the first harmonic light beam combined with the second harmonic light beam; and data processing circuitry configured to determine an electron density of the plasma based on an electron contribution to a refractive index of the plasma indicated by the interference pattern.

In some aspects, the techniques described herein relate to a method for measuring electron density within a plasma, the method including: emitting, by a laser source, a light beam; generating, by a first second harmonic generation (SHG) component configured to receive the light beam, a first harmonic light beam with a first polarization; passing the light beam and the first harmonic light beam through a plasma chamber containing a plasma to shift a phase of the light beam and the first harmonic light beam; generating, by a second SHG component configured to receive the light beam after passing through the plasma chamber, a second harmonic light beam that has a second polarization; detecting, by a heterodyne detection component, an interference pattern of the first harmonic light beam combined with the second harmonic light beam; and determining, by data processing circuitry, an electron density of the plasma based on an electron contribution to a refractive index of the plasma indicated by the interference pattern.

In some aspects, the techniques described herein relate to a non-transitory, computer-readable medium including instructions that, when executed by one or more processors, cause the one or more processors to: receive, from a heterodyne detection component, data indicating an interference pattern associated with a first harmonic light beam having a first polarization and a second harmonic light beam having a second polarization, the first harmonic light beam being generated by a light beam passing through a first second harmonic generation (SHG) component, the second harmonic light beam being generated by the light beam passing through a second SHG component after passing through a plasma chamber to shift a phase of the light beam; and determining an electron density of the plasma based on an electron contribution to a refractive index of the plasma indicated by the interference pattern.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example measurement system for measuring electron density within a plasma, in accordance with various embodiments described herein.

FIG. 2A is a schematic diagram for an example measurement system for measuring electron density within a plasma, in accordance with various embodiments described herein.

FIG. 2B is a schematic diagram for an example fiber-based measurement system for measuring electron density within a plasma, in accordance with various embodiments described herein.

FIG. 2C depicts an example plasma chamber shockwave generation process for simulating an electron density change, in accordance with various embodiments described herein.

FIG. 3A is a plot of a test plasma density profile for simulating interferometric signals and noise/background suppression characteristics of the example measurement systems of FIGS. 2A and 2B, in accordance with various embodiments described herein.

FIG. 3B is a plot of a simulated two-color heterodyne signal including uniformly distributed, uncorrelated noise used to simulate noise/background suppression characteristics of the example measurement systems of FIGS. 2A and 2B, in accordance with various embodiments described herein.

FIG. 3C is a plot of a retrieved phase signal from a simulated two-color heterodyne signal based on the example measurement systems of FIGS. 2A and 2B in comparison with a true phase signal, in accordance with various embodiments described herein.

FIG. 4A is a plot of an example measured heterodyne signal and reference signal without plasma, in accordance with various embodiments described herein.

FIG. 4B is a plot of an example measured reference signal and heterodyne signal power spectral density based on the signals of FIG. 4A, in accordance with various embodiments described herein.

FIG. 4C is a plot of example phase measurements for the measured reference signal and heterodyne signals indicated in FIG. 4B, in accordance with various embodiments described herein.

FIG. 4D is a plot of phase error versus an effective measurement rate based on the example phase measurements of FIG. 4C, in accordance with various embodiments described herein.

FIG. 4E is a plot of an example phase measurement synchronized with a current pulse, in accordance with various embodiments described herein.

FIG. 4F is a plot of an example conversion of the phase change to electron density, in accordance with various embodiments described herein.

FIG. 5 depicts a flow diagram representing an example computer-implemented method for measuring electron density within a plasma, in accordance with various embodiments described herein.

### DETAILED DESCRIPTION

The systems and methods of the present disclosure include two-color heterodyne interferometry (TCHI) systems for direct, high-speed measurements of electron density (also referenced herein as “electron number density”) in plasma. These systems leverage the principles of two-color interferometry, incorporating heterodyne detection, multiple second harmonic generation (SHG) components, and common-path interferometry to enable precise, interference-tolerant measurements of electron density. For example, by creating and interfering two second harmonic light beams from a source (e.g., fundamental) light beam in the manners described herein, the present systems overcome many of the challenges experienced by common techniques by enhancing measurement sensitivity, dynamic range, and spatial and temporal resolution. While described herein primarily in terms of SHG and light beams resulting from SHG components/stages, it should be appreciated that the harmonic light signals described herein may include light signals that are a third, fourth, fifth, and/or any other suitable harmonic of a light beam (e.g., a fundamental light beam).

In particular, the TCHI systems described herein can accurately measure electron density with high temporal resolution exceeding approximately 1 megahertz (MHz) and spatial resolution of less than approximately 5 millimeters (mm). The TCHI systems may utilize a common-path interferometer configuration that employs SHG to measure the dispersion caused by electrons in the plasma. By focusing on the difference in optical path length or refractive index between the two different wavelengths resulting from the SHG, the THCI systems can directly measure the electron contribution to the plasma index of refraction, minimizing sensitivity to the neutral particle contribution to the plasma index of refraction.

The TCHI systems described herein also incorporate a heterodyne detection component and technique, which significantly reduces noise associated with detection electronics, thereby enhancing the measurement accuracy and reliability. This approach generally allows for suppression of low-frequency electronic noise and achieving high sensitivity and dynamic range in electron density measurements. Namely, the approximate dynamic range of the TCHI systems described herein spans nearly four orders of magnitude, from 10¹³ to 10¹⁷ cm⁻³, making these systems suitable for a wide range of plasma diagnostics applications.

Furthermore, the TCHI systems described herein can perform these electron density measurements in a non-intrusive manner (e.g., without requiring direct contact with the plasma). This presents a significant advantage over many techniques where the plasma environment is hostile or inaccessible. As such, the TCHI systems described herein enable real-time monitoring and control of plasma processes in various industrial and research applications (e.g., spacecraft re-entry, nuclear fusion, semiconductor manufacturing) that were previously difficult to monitor.

Moreover, in certain embodiments, the TCHI system includes a fiber-based implementation which significantly reduces the impact of vibration and air currents common in free-space interferometric techniques as potential noise sources. These implementations thereby yield a generally more stable and reliable measurement system than was previously accomplished. The heterodyne detection component, particularly when implemented as a fiber-based system, provides an additional layer of precision by ensuring that the first and second harmonic light beams are coupled into a single polarization-maintaining fiber. This not only simplifies the TCHI system's architecture but also improves the stability and accuracy of the interference pattern detection, which correspondingly improves the electron density determination accuracy.

Overall, the TCHI systems described herein provide electron density measurements with an accuracy and sensitivity that typical systems often fail to provide. For example, the TCHI systems meet the stringent requirements of high-speed aerospace applications, providing data to validate computational fluid dynamics models and facilitate development of thermal protection systems (e.g., for radiative heating effects during planetary reentry phases of spacecraft).

Further, the present disclosure includes specific features other than what is well-understood, routine, conventional activity in the field, or adding unconventional steps that demonstrate, in various embodiments, particular useful applications, e.g., a first second harmonic generation (SHG) component configured to receive the light beam and generate a first harmonic light beam with a first polarization; a plasma chamber containing a plasma, wherein the light beam and the first harmonic light beam pass through the plasma chamber to shift a phase of the light beam and the first harmonic light beam; a second SHG component configured to receive the light beam after passing through the plasma chamber and generate a second harmonic light beam that has a second polarization; and/or a heterodyne detection component configured to detect an interference pattern of the first harmonic light beam combined with the second harmonic light beam, among others.

Of course, it should be appreciated that the advantages and technical improvements described above and elsewhere herein are not the only advantages and/or technical improvements that may be realized as a result of the techniques described herein.

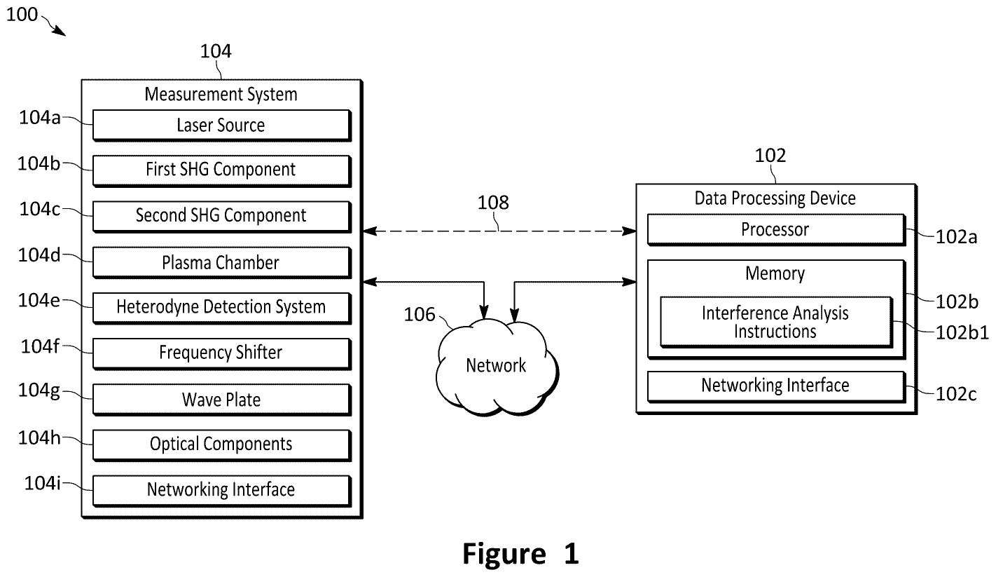

FIG. 1 depicts an example measurement system 100 for measuring electron density within a plasma, in accordance with various embodiments described herein. Depending on the embodiment, the example measurement system 100 includes a data processing device 102 and a measurement system 104 that generally perform electron density measurements using a light beam (e.g., laser light) emitted from a laser source 104a that passes through and/or otherwise interacts with one or more of the other components of the measurement system 100. Specifically, the measurement system 104 may generate and measure an interference pattern between two harmonic light signals generated from a light beam (e.g., emitted by the laser source 104a) having a fundamental frequency. Data measured by the measurement system 104 representing the interference pattern may be transmitted to the data processing device 102 for processing/analysis to determine an electron density of a plasma (e.g., within plasma chamber 104d) based on an electron contribution to a refractive index of the plasma indicated by the interference pattern data.

More generally, the example measurement system 100 utilizes interferometric techniques (e.g., two-color interferometry, common-path interferometry) to determine plasma densities, and more specifically, the electron density within a plasma. Interferometry is a classical technique for measuring the path-integrated density of plasmas and gases. The working principle relies on optical properties of the medium (e.g., plasma within the plasma chamber 104d) and the linear relationship between the density and the refractive index. Spatial and temporal variations in the refractive index are generally translated into phase shifts that are detected (e.g., by the heterodyne detection system 104e) by interfering a monochromatic probe electromagnetic wave with a reference electromagnetic wave.

As previously mentioned, a significant challenge in weakly ionized plasmas is that both the neutral gas and electrons comprising the plasma may contribute to the plasma's refractive index. In general, one can express the refractive index as,

$$n - 1 = \sum {K}_{gd . i} {N}_{i} , \qquad ( 1 )$$

where K_{gd,i} is the Gladstone-Dale constant that relates the refractive index n and gas density Nᵢ. The summation in Equation (1) is over the species (e.g., neutral particles, electrons, etc.) present in the fluid. For neutral constituents, the Gladstone-Dale constant is positive and displays a relatively weak dependence on wavelength. By contrast, the electron Gladstone-Dale constant is negative and highly dispersive. In fact, for a cold plasma at optical frequencies, the Gladstone-Dale constant for electrons can be represented as,

$${K}_{gd , e} = - \frac{1}{2 {n}_{c}} , \qquad ( 2 ) ,$$

where n_{c} is the critical density, n_{c}=π/λ²rₑ, where rₑ=2.818 femtometers (fm) is the classical electron radius and λ is the wavelength of light. With the strong wavelength dependence indicated by equation (2), separating the electron contribution and the neutral contribution (also referenced herein as “background”) to the plasma refractive index can be performed by making measurements at two different, relatively widely separated, wavelengths. In particular, the typical two-color interferometer systems may determine a path-integrated phase change of a probe wave. For a uniform medium of length L, this phase change can be expressed as,

$$ϕ = \frac{2 π L}{λ} \sum {K}_{gd , i} {N}_{i} \qquad ( 3 )$$

For a medium consisting of a neutral mixture and an electron component, phase measurements at two different wavelengths λ₁, λ₂ can be used to obtain the electron density, Nₑ, independent of the neutral component as,

$${N}_{e} = \frac{1}{{r}_{e} L} [ \frac{{λ}_{1} {ϕ}_{1} - {λ}_{2} {ϕ}_{2}}{{λ}_{1}^{2} - {λ}_{2}^{2}} ] \qquad ( 4 )$$

The electron density represented by equation (4) neglects any slight variations in K_{gd} with wavelength. This technique has successfully been applied to numerous weakly ionized plasmas but requires two superimposed interferometry systems. It is often convenient to use a laser and its second harmonic, such as 1064 nanometer (nm) and 532 nm wavelengths. Substituting the expression λ₂=λ₁/2, for the second harmonic wavelength in equation (4) yields,

$${N}_{e} = \frac{2}{3 {r}_{e} L {λ}_{1}} [ 2 {ϕ}_{1} - {ϕ}_{2} ] \qquad ( 5 )$$

Accordingly, as indicated by equation (5) the two-color interferometric approach to measuring electron contributions to refractivity is fundamentally limited by the phase detection sensitivity and any imperfections in the experiment, such as path-length changes due to window vibrations, mirror vibrations, air currents in the beam path, and/or detector noise. In particular, two-color measurements can be challenging in the presence of a large neutral contribution, as the electron effect will sit on top of a large neutral phase shift. As a consequence, small percentage errors in measuring the overall phase shift can overwhelm the electron signal. Thus, the example measurement system 100 is configured to reduce the effects of such neutral (and other) contributions to resolve the much smaller electron contribution by leveraging, for example, SHG, heterodyne signals, and/or common-path interferometric techniques in combination with two-color interferometric techniques.

As an example, a first SHG component 104b may receive the light beam emitted from the laser source 104a and may generate a first harmonic light beam (e.g., having twice the frequency of the light beam emitted from the laser source 104a). The light beam and the first harmonic light beam may co-propagate through the plasma chamber 104d and may interact with (e.g., pass through) a plasma contained therein and/or a shockwave passing through the plasma, resulting in a phase change of the two light beams. These phase-adjusted, co-propagating light beams (e.g., light beam from laser source 104a and first harmonic light beam) may then interact with a beam splitter (e.g., a dichroic beam splitter), such that the light beam from the laser source 104a continues to a second SHG component 104c and the first harmonic light beam propagates to additional optical components (e.g., optical components 104h). The second SHG component 104c may generate a second harmonic light beam (e.g., having twice the frequency of the light beam emitted from the laser source 104a). These co-propagating light beams (e.g., light beam from laser source 104a and second harmonic light beam) may interact with a beam splitter (e.g., a dichroic beam splitter), and the light beam from the laser source 104a may proceed to beam dump while the second harmonic light beam propagates to additional optical components (e.g., optical components 104h), where the second harmonic light beam may be recombined/interfere with the first harmonic light beam and detected/measured by a heterodyne detection component 104c.

The measurement system 104 further includes one or more components that are configured to facilitate the interferometric techniques described herein, such as a frequency shifter 104f, a wave plate 104g, and one or more other optical components 104h. The frequency shifter 104f may shift the frequency of one of the harmonic light beams (e.g., light beams generated by the first/second SHG components 104b, 104c) to create a beat frequency within the interference signal of resulting from the re-combination of the first harmonic light beam with the second harmonic light beam. The wave plate 104g generally adjusts the polarization of one of the first harmonic light beam or the second harmonic light beam, and in certain instances, is a quarter wave plate configured to adjust the polarization of the first/second harmonic light beam by a quarter wavelength (e.g., by) 90°. The frequency shifter 104f and the wave plate 104g collectively adjust one of the first/second harmonic light beams, such that the resulting combination of beams detected by the heterodyne detection component 104e is comprised of two distinct polarizations and creates a heterodyne interference signal with a beat frequency imposed by the frequency shifter 104f. The optical components 104h may include, for example, optical fiber cables, lenses, mirrors, isolators, collimators, beam dumps, and/or any suitable optical components or combinations thereof.

The first harmonic light beam and the second harmonic light beam may recombine/interfere at/within the heterodyne detection system 104e and thereafter co-propagate within the heterodyne detection system 104c, which in certain instances, may be a completely fiber-based system. The heterodyne detection system 104e may detect the interference pattern between the first/second harmonic light beams and measure the interference pattern as a signal, which may be a self-referenced heterodyne signal encoding the electron contribution to the refractive index of the plasma. This self-referenced heterodyne signal may have a heterodyne frequency that is in a radio frequency (RF) domain, such as from approximately 1 MHz to approximately 100 MHz. The heterodyne detection system 104e may include, for example, a single-point photodetector for zero-dimension (OD) high-speed measurements and/or an electro-optical camera configured to capture images of the interference pattern (e.g., interference fringes) between the first/second harmonic light beam for two-dimensional (2D) measurements.

The measurement system 104 may detect/measure interference pattern data (referenced herein as “interference signals”) associated with the first and second harmonic light beams via the heterodyne detection system 104e and may transmit the measured data to the data processing device 102. The data processing device 102 includes interference analysis instructions 102b1 configured to receive the interference signals (e.g., between the first and second harmonic light signals) and determine an electron density within a plasma of the plasma chamber 104d. Generally, the data processing device 102 retrieves electron density profiles from the measured data (e.g., interference signals) by phase demodulation, as part of post-processing the signals. More specifically, the data processing device 102 is configured to determine an electron contribution to the refractive index of the plasma based on the interference signal generated by the interfering harmonic light beams, from which the data processing device 102 determines the electron density within the plasma.

In certain embodiments, the interference analysis instructions 102b1 cause the device 102 to down-shift one of the first harmonic light beam or the second harmonic light beam, depending on which harmonic light beam was frequency shifted by, for example, the frequency shifter 104f. Further in these embodiments, the instructions 102b1 cause the device 102 to apply/perform an inverse Fourier transform to the measured interference signal data (e.g., a self-referenced heterodyne signal) and a reference signal. The instructions 102b1 may then cause the device 102 to determine a phase change of the self-referenced heterodyne signal based on the inverse Fourier transform.

Of course, it should be appreciated that, while the various components of the example measurement system 100 (e.g., data processing device 102, measurement system 104, etc.) are illustrated in FIG. 1 as single components, the example measurement system 100 may include multiple processors 102a, memories 102b, laser sources 104a, plasma chambers 104d, heterodyne detection systems 104e, frequency shifters 104f, wave plates 104g, and/or other optical components 104h that are simultaneously connected (e.g., via physical communication links 108, network 106) at any given time. For example, the measurement system 104 may include two laser sources 104a configured to emit different wavelengths of light that pass through one or more of the various components included in the system 104 for the heterodyne detection system 104e to detect and transmit to the data processing device 102 (e.g., via networking interface 104i).

The laser source 104a may generally be configured to emit laser light (e.g., light beams) in the infrared (IR) spectrum, such as in the near-IR (e.g., 1064 nm). In these instances, the harmonic light beams generated by the SHG components 104b, 104c may generate harmonic light beams with wavelengths of approximately 532 nm. However, it should be appreciated that the laser source 104a may be configured to emit light at any suitable wavelength.

The SHG components 104b, 104c are generally configured to receive light and generate a second harmonic light beam that has half the wavelength of the received (e.g., fundamental) light beam. For example, the first SHG component 104b and the second SHG component 104c may be nonlinear crystals, and the first SHG component may be a periodically poled stoichiometric lithium tantalate (PPSLT) crystal and the second SHG component may be a periodically poled lithium niobate (PPLN) crystal. However, it should be appreciated that the SHG components 104b, 104c may be any suitable crystals and/or other components configured to generate second harmonic light beams.

More generally, the data processing device 102 includes the one or more processors 102a, the memory 102b, and a networking interface 102c. The memory 102b stores executable instructions that are configured to, when executed by the one or more processors 102a, cause the one or more processors 102a to analyze data (e.g., interference signal data) received at the data processing device 102 and output various values (e.g., electron density, electron contribution to plasma refractive index). The interference analysis instructions 102b1 include such executable instructions, as well as other data. The memory 102b may also store additional data and/or databases. The data processing device 102 receives data from the measurement system 104 through a network 106 and/or through physical communication links 108 (e.g., via networking interfaces 102c, 104i) and processes the data in accordance with one or more sets of instructions stored in the memory 102b to output any of the values described herein.

It should be appreciated that the data processing device 102 can include one or multiple computing devices that are co-located or distributed. Moreover, in some embodiments, the data processing device 102 is located/stored in a remote location from the measurement system 104 (e.g., a cloud-based server). In these embodiments, the measurement system 104 accesses the data processing device 102 by transmitting data (e.g., interference signal data) to the cloud-based server. The data processing device 102 analyzes the inputs (e.g., using interference analysis instructions 102b1) and generates outputs (e.g., electron density, electron contribution to plasma refractive index).

The one or more processors 102a may include any suitable number of processors and/or processor types. For example, the one or more processors 102a may include one or more CPUs and one or more graphics processing units (GPUs). Generally, the one or more processors 102a may be configured to execute software instructions stored in the memories 102b, which may include one or more persistent memories (e.g., a hard drive and/or solid-state memory).

The networking interface 102c may enable the data processing device 102 to communicate with the measurement system 104 and/or any other connected devices or combinations thereof through the networking interface 104i. The networking interfaces 102c, 104i generally support one or more of the communication/network protocols implemented by the network 106. Moreover, the network 106 may be a single communication network, or may include multiple communication networks of one or more types (e.g., one or more wired and/or PANs or LANs, and/or one or more WANs such as the Internet). In some embodiments, the network 106 includes multiple, entirely distinct networks.

It will be understood that the above disclosure is one example and does not necessarily describe every possible embodiment. As such, it will be further understood that alternate embodiments may include fewer, alternate, and/or additional steps or elements.

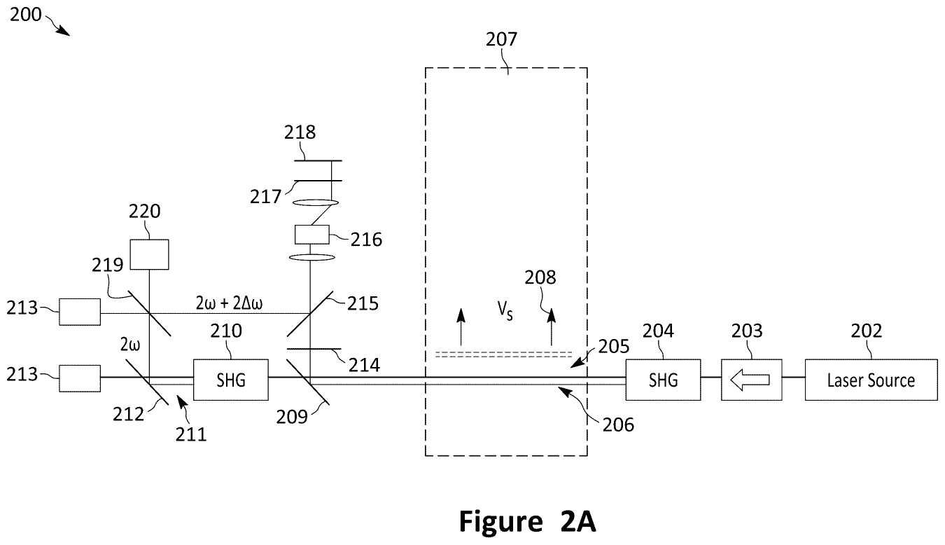

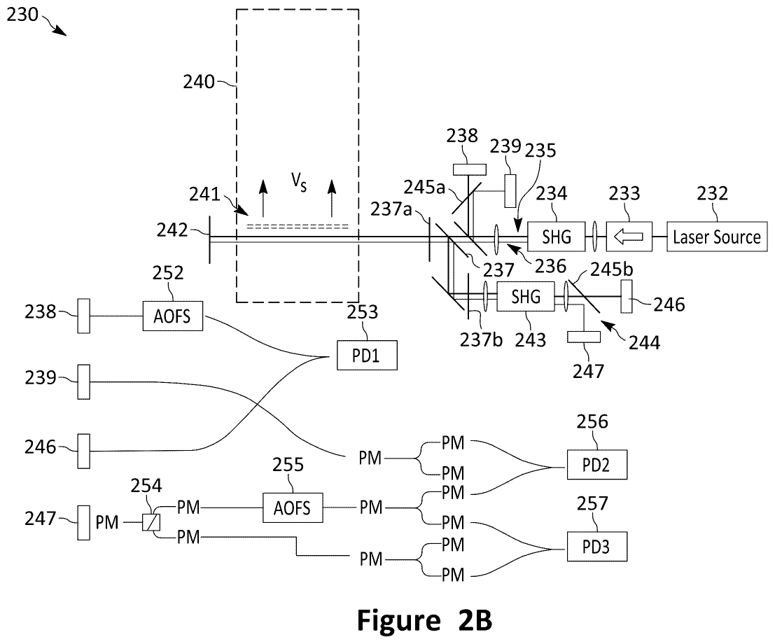

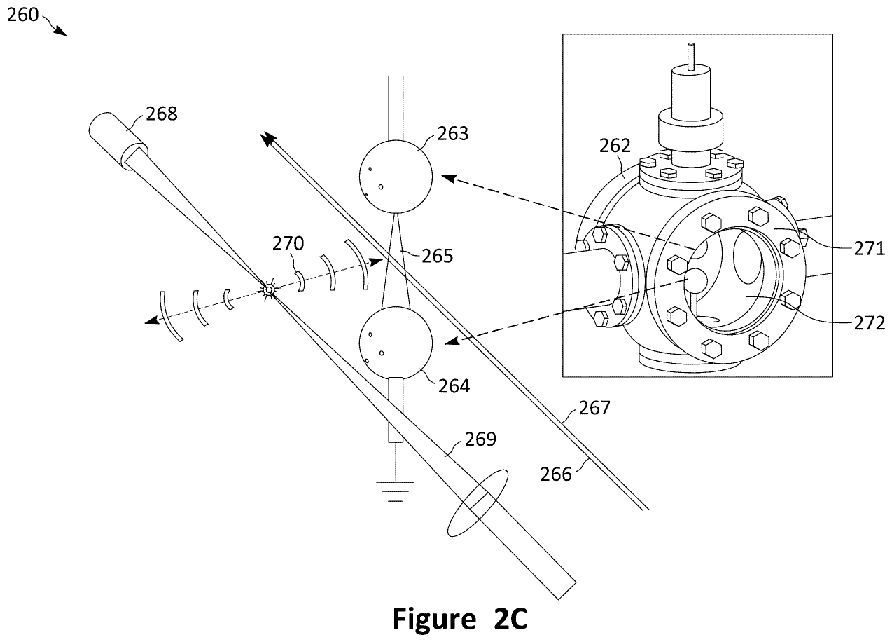

FIG. 2A is a schematic diagram for an example measurement system 200 for measuring electron density within a plasma, in accordance with various embodiments described herein. This example measurement system 200 reduces the issues experienced by typical systems by directly eliminating the neutral contribution to the refractive index on the resulting detected interference signals. Generally, a single frequency laser beam emitted by the laser source 202 is isolated at an isolator 203 and then frequency doubled at a first SHG component 204 to generate a first color probe beam (e.g., first harmonic light beam 206), and the residual fundamental light (e.g., light beam 205) serves as the second color probe beam. These two probe beams 205, 206 pass through a plasma chamber 207 containing a plasma that induces a phase shift in both probe beams 205, 206. The plasma chamber 207 may also include a shockwave 208 passing through the plasma medium (e.g., at a velocity Vs), that may be generated by a second laser source (not shown) emitting a laser pulse proximate/adjacent to the plasma. This shockwave 208 may simulate a change in the electron density of the plasma, which may induce a different phase change in the probe beams 205, 206 than if the shockwave 208 was not present.

When the probe beams 205, 206 pass through the plasma chamber 207, the example measurement system deviates from a typical two-color interferometer. In particular, rather than separating the two probe beams 205, 206 and separately interfering them with reference beams (as is typically performed in two-color interferometry), the probe beams 205, 206 reach a dichroic beam splitter 209 that reflects the first harmonic light beam 206 and transmits the light beam 205, and the light beam 205 is again frequency doubled by a second SHG component 210. During this second harmonic process, phase matching requires that the second harmonic light beam 211 has double the phase of the light beam 205, which naturally produces the 201 term in equation (5). In certain embodiments, the example measurement system 200 may further include a polarizer (not shown) positioned before or after the dichroic beam splitter 209 to adjust the polarization of the light beam 205 and/or the first harmonic light beam 206. In doing so, the polarizer may reduce/eliminate cross-talk between the two channels/signals of the heterodyne combination occurring at the beam splitter 219, as detected at the detection system 220, and/or otherwise co-propagating through the heterodyne detection systems described herein (e.g., 104c).

From the second SHG component 210, the light beam 205 and second harmonic light beam interact with another dichroic beam splitter 212 that reflects the second harmonic light beam 211 and transmits the light beam 205 into beam dumps 213. The first harmonic light beam 206 subsequently passes through a half wave plate 214 a polarizing beam splitter 215, an acousto-optic frequency shifter 216, and a quarter wave plate 217 before reflecting from a mirror 218 and re-transmitting through the quarter wave plate 217 and reflecting from the polarizing beam splitter 215. Thus, when the first harmonic beam 206 and the second harmonic beam 211 reach the beam splitter 219, the second harmonic beam 211 has a frequency represented by the expression 20 (twice the fundamental frequency of the light beam 205), and the first harmonic beam 206 has a frequency represented by the expression 2ω+2Δω (including additional frequency shift from frequency shifter 216). This additional frequency shift may be of any suitable value, such as 80 MHz.

A first portion of the beams 206, 211 transmit/reflect into the beam dumps 213 and a second portion of the beams 206, 211 transmit/reflect into the detection system 220 (e.g., heterodyne detection system 104c). Interference between the first harmonic light beam 206 and the second harmonic light beam 211 results in an oscillating term 1+cos(2φ₁−φ₂) which data processing systems (e.g., data processing device 102) can use to infer the electron density. In certain instances, the detection system 220 is a fast photodiode.

In certain embodiments, the example measurement system 200 can be a common path harmonic interferometer that retains the desirable features of other common path interferometers (e.g., insensitivity to vibrations in the test apparatus such as optical lenses, mirrors, and windows). Moreover, the design of the example measurement system 200 provides a direct measure of all dynamic variations in the dispersion (e.g., wavelength sensitivity) of the optical elements. Because the natural dispersion of air results in a change in the Gladstone-Dale constant of only one percent between visible and IR wavelengths, the example measurement system 200 suppresses the neutral contribution to the signal by a factor of approximately one hundred, in various examples. Additionally, this background suppression characteristic of the example measurement system 200 may substantially reduce the electron density measurement noise relative to typical two-color interferometry techniques. Further, frequency shifting the first harmonic light beam 206 suppresses electronic noise present at lower detection frequencies.

FIG. 2B is a schematic diagram for an example fiber-based measurement system 230 for measuring electron density within a plasma, in accordance with various embodiments described herein. This example fiber-based measurement system 230 reduces/eliminates vibration and air currents present in free-space interferometers as potential noise sources, yielding a more stable/robust electron density measurement and measurement system. Moreover, the two-color heterodyne interferometry is fulfilled using polarization maintaining (PM) fiber optics instead of free-space optics, which may further improve the integrity and performance (e.g., accuracy) of the system 230.

The example fiber-based measurement system 230 includes a laser source 232 that emits a light beam 235 that passes through an isolator 233 before reaching a first SHG component 234 to generate a first harmonic light beam 236. These beams 235, 236 interact with a first dichroic beam splitter 245a and a first portion of the light beam 235 reaches a first fiber port 238 and a first portion of the first harmonic light beam 236 reaches a second fiber port 239.

A second portion of the beams 235, 236 transmit through the beam splitter and through a polarizing beam splitter 237 before reaching a plasma chamber 240. The plasma chamber 240 generally contains a plasma that induces a phase shift in both second portions of the light beams 235, 236. The plasma chamber 240 may also include a shockwave 241 passing through the plasma medium (e.g., at a velocity Vₛ), that may be generated by a second laser source (not shown) emitting a laser pulse proximate/adjacent to the plasma. This shockwave 241 may simulate a change in the electron density of the plasma, which may induce a different phase change in the second portions of the light beams 235, 236 than if the shockwave 241 was not present.

The second portions of the light beams 235, 236 reflect from a mirror 242 and subsequently pass through the plasma chamber 240, thereby inducing a subsequent phase change in the second portions of the light beams 235, 236. The second portions of the light beams 235, 236 again reach the polarizing beam splitter 237 and are reflected into a second SHG component 243 to generate a second harmonic light beam (both harmonic light beams collectively represented by composite harmonic light beam 244). In certain embodiments, the example fiber-based measurement system 230 may further include a polarizer (not shown) positioned before or after the wave plate 237b to adjust the polarization of the second portions of the light beams 235, 236. In doing so, the polarizer may reduce/eliminate cross-talk between the two channels/signals of the heterodyne combination occurring at the second dichroic beam splitter 245b, as detected at the fourth fiber port 247, and/or otherwise co-propagating through the heterodyne detection systems described herein (e.g., 104c).

Before and after reaching the polarizing beam splitter 237, the second portions of the light beams 235, 236 may also pass through wave plates 237a, 237b that may adjust the polarization of the second portions of the light beams 235, 236. The second portion of the light beam 235 and the composite harmonic light beam 244 may reach a second dichroic beam splitter 245b where the second portion of the light beam 235 transmits into a third fiber port 246 and the harmonic light beam transmits into a fourth fiber port 247.

The first fiber port 238 transmits the first portion of the light beam 235 into an acousto-optic frequency shifter 252 that shifts the frequency of the first portion of the light beam 235 before the first portion of the light beam 235 reaches a first photodiode detector 253 to serve as a first part of a reference measurement (e.g., a reference signal). The second fiber port 239 transmits the first portion of the first harmonic light beam 236 through PM fiber optic cables into the second photodiode detector 256 to serve as a first part of a reference harmonic measurement based on the first harmonic light beam 236. The third fiber port 246 transmits the second portion of the light beam 235 into the first photodiode detector 253 to serve as a second part of the reference measurement based on the light beam 235. The fourth fiber port 247 transmits the composite harmonic light beam 244 into a PM polarizing splitter 254 that splits the composite harmonic light beam 244 into the second portion of the first harmonic light beam 236 and the second harmonic light beam. The PM polarizing splitter 254 transmits the second portion of the first harmonic light beam 236 into an acousto-optic frequency shifter 255 and then to the second photodiode detector 256 to serve as a second part of the reference harmonic measurement based on the first harmonic light beam 236. The PM polarizing splitter 254 also transmits the second portion of the first harmonic light beam 236 to a third photodiode detector 257 to serve as a first part of a common-path measurement based on the harmonic light beams (e.g., first 236 and second). The PM polarizing splitter 254 further transmits the second harmonic light beam into the third photodiode detector 257 to serve as a second part of the common-path measurement based on the harmonic light beams. In certain embodiments, the fiber optics used to transmit the light beams (e.g., 235, 236, 244) are polarization maintaining to perform the direct electron measurement using two-color heterodyne interferometry techniques described herein.

FIG. 2C depicts an example plasma chamber shockwave generation process 260 for simulating an electron number density change, in accordance with various embodiments described herein. The process 260 generally includes generating a shockwave 270 through plasma 265 within a plasma chamber 262 to simulate an electron number density change within the plasma 265 that will influence the phase shift of the probe light beams (e.g., fundamental light beam 267 and first harmonic light beam 266) and the resulting interference pattern between the harmonic light beams (e.g., first harmonic light beam 266 and a second harmonic light beam (not shown).

Broadly, the plasma chamber 262 includes an anode 263 through which high voltage is driven to create a plasma 265 (e.g., a direct current (DC) discharge plasma) between the anode 263 and a cathode 264. A second light source 268 emits a light pulse 269 that generates a shockwave 270 within the plasma chamber 262 and that passes through the plasma 265, simulating an electron number density change within the plasma 265. The light beam 266 and the first harmonic light beam 267 pass through the plasma 265 as the shockwave 270 reaches the plasma 265, and are thereby affected (e.g., phase-shifted) as a result of the shockwave's 270 influence on the plasma 265.

More specifically, the plasma chamber 262 provides optical access via two round viewports (one illustrated in FIG. 2C as viewport 271), both of which may be outfitted with plane uncoated ultraviolet (UV) fused silica windows 272. The clear aperture of the circular windows 272 may be, for example, approximately two inches in diameter, but may be of any suitable size. The plasma 265 (e.g., surrogate DC discharge plasma) may be generated in a low-pressure gas between the anode 263 and the cathode 264 using a high voltage power supply. In this example, the plasma environment may have electron number densities on the order of approximately 10¹⁸˜10²⁰ m⁻³ with gas pressures of approximately a few Torr. To generate the shockwave 270, the second laser source 268 may be a high-intensity short-pulse laser source with a focal point of the laser pulse being adjacent to the DC discharge afterglow of the plasma 265. The shockwave 270 from the laser-induced breakdown propagates through the plasma 265 to simulate a change in electron number density across the shockwave 270, which will produce a discontinuity in the electron distribution, and will impact the phase of the probe beams 266, 267.

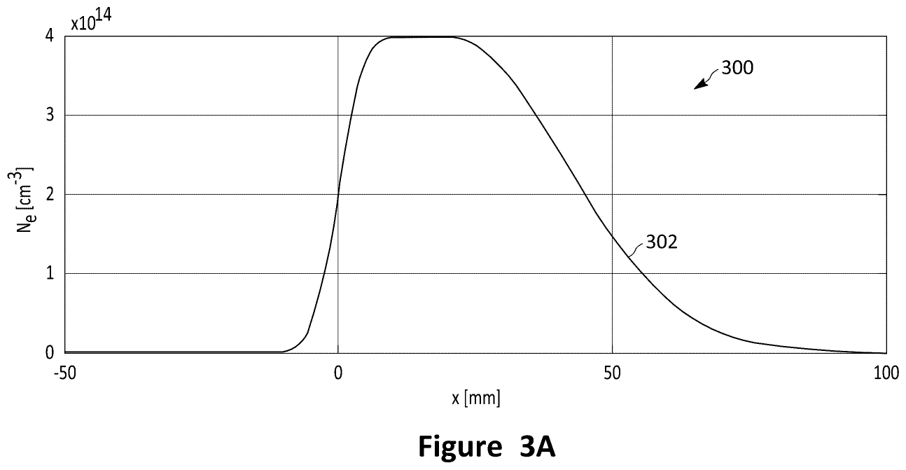

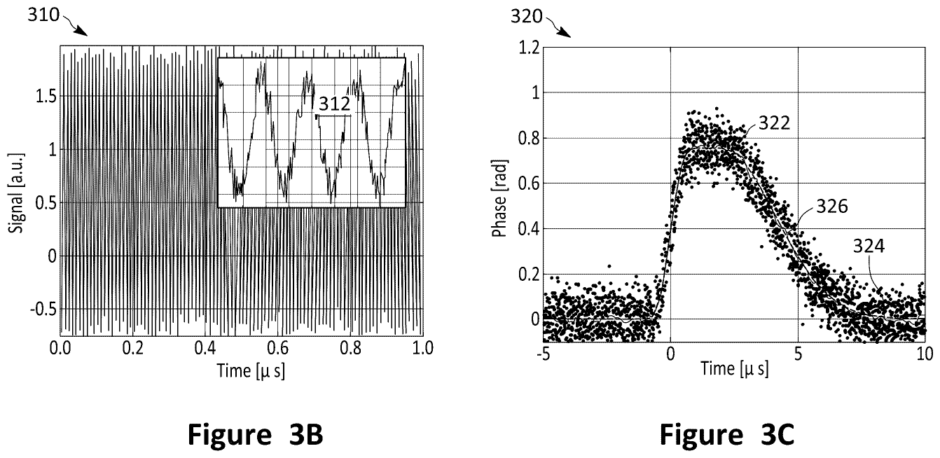

FIG. 3A is a plot 300 of a test plasma density profile 302 for simulating interferometric signals and noise/background suppression characteristics of the example measurement systems 200, 230 of FIGS. 2A and 2B, in accordance with various embodiments described herein. In particular, the test plasma density profile 302 includes a peak value of approximately N_{e,0}=4×10¹⁴ centimeters (cm) used for simulating two-color heterodyne interferometer interference signals to determine expected signal levels and measurement uncertainty. For example, evaluation of the diagnostic sensitivity can be performed through simulations of the two-color heterodyne interferometer signals acquired using either of the example measurement systems 200, 230 of FIGS. 2A and 2B based on equation (5) and the test electron density profile 302 shown in FIG. 3A. This spatial profile represented by the test plasma density profile 302 may convect through the measurement location of the measurement systems 200, 230 at a constant velocity of approximately 10 kilometers per second (km/s) and/or at any suitable rate.

FIG. 3B is a plot 310 of a simulated two-color heterodyne signal including uniformly distributed, uncorrelated noise 312 used to simulate noise/background suppression characteristics of the example measurement systems 200, 230 of FIGS. 2A and 2B, in accordance with various embodiments described herein. Generally, the plot 310 represents a simulated 100 MHz two-color heterodyne signal sampled at approximately five gigasamples per second (GS/sec) that includes uniformly distributed uncorrelated noise with approximately 40% signal amplitude. For the simulation represented by the plot 310, the plasma may have a peak electron density of approximately 4×10¹⁴ cm⁻³ behind the shockwave and a path length of approximately 0.2 meters (m). This simulated heterodyne measurement is also proportional to the term 1+cos(2φ₁−φ₂) that may be derived from equation (5).

FIG. 3C is a plot 320 of a retrieved phase signal from a simulated two-color heterodyne signal based on the example measurement systems 200, 230 of FIGS. 2A and 2B in comparison with a true phase signal, in accordance with various embodiments described herein. The plot 320 includes a retrieved phase profile 322 (e.g., represented by the scattered dots), an actual phase profile 324 (e.g., represented by the dashed line), and a down-sampled measurement profile 326 (e.g., represented by the solid line). The retrieved phase profile 322 may generally be retrieved from the heterodyne signal using an inverse Fourier transform method, as described herein, when compared with the actual phase profile 324, which may be proportional to a test electron density profile (e.g., test plasma density profile 302) behind a shockwave traveling at approximately ten km/s.

As illustrated in FIG. 3C, the actual phase profile 324 and the down-sampled measurement profile 326 show high agreement and demonstrate the noise suppression characteristics of the heterodyne method. While the random error for a single data point may be approximately 66 mrad, the 50-point moving average (e.g., filtered to an approximate 100 MHz effective measurement rate) may include a random error of less than 12 mrad with a corresponding detection limit of approximately 2.4×10¹³ cm⁻³. Further, the heterodyne method generally provides flexibility to tune the detection parameters to minimize noise and achieve high sensitivity.

In principle, there is no ceiling on the detectable range of Nₑ. However, the carrier frequency determines the maximum measurable rate of change, dNₑ/dt. Thus, estimating a steep rising edge to be approximately one microsecond (μs) wide, the systems described herein may have a corresponding electron density ceiling of approximately 2.2×10¹⁷ cm⁻³, which can be increased by, for example, raising the heterodyne frequency.

Accordingly, the simulations and general system configuration generally represented by FIGS. 2A-3C demonstrate several features of the techniques described herein improve plasma profiling over typical methods. For example, the systems described herein feature a straightforward implementation that utilizes a single line of sight across the shockwave, utilize common-path detections to provide suppression of the neutral contribution to the refractive index and tolerance to window vibrations, and further utilize heterodyne detection allowing suppression of low frequency electronic noise and simultaneous high sensitivity and dynamic range. Moreover, the present techniques do not require a high-pulsed energy laser, thereby reducing/eliminating the potential for laser-induced damage on optics and windows of the equipment.

Based on these considerations, the present techniques can improve plasma measurement sensitivity in some areas by approximately two orders of magnitude (e.g., from approximately 1015 cm⁻³ to approximately 1013 cm⁻³) while increasing the measurement rate by approximately two orders of magnitude (e.g., from 1 MHz to 100+ MHz). Further, the present techniques can yield an expected dynamic range of approximately 1013-1017 cm⁻³, or four orders of magnitude, which typical systems and methods were often unable to provide.

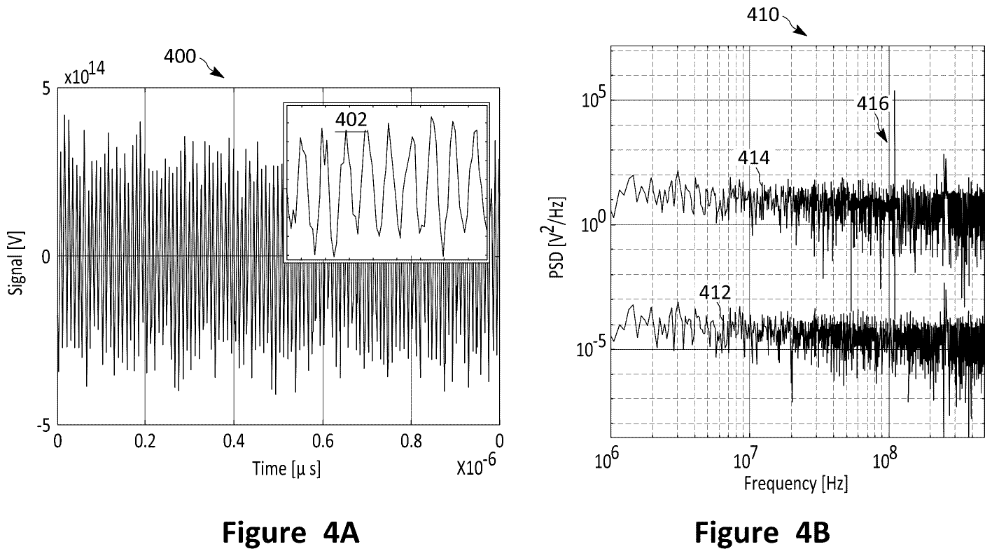

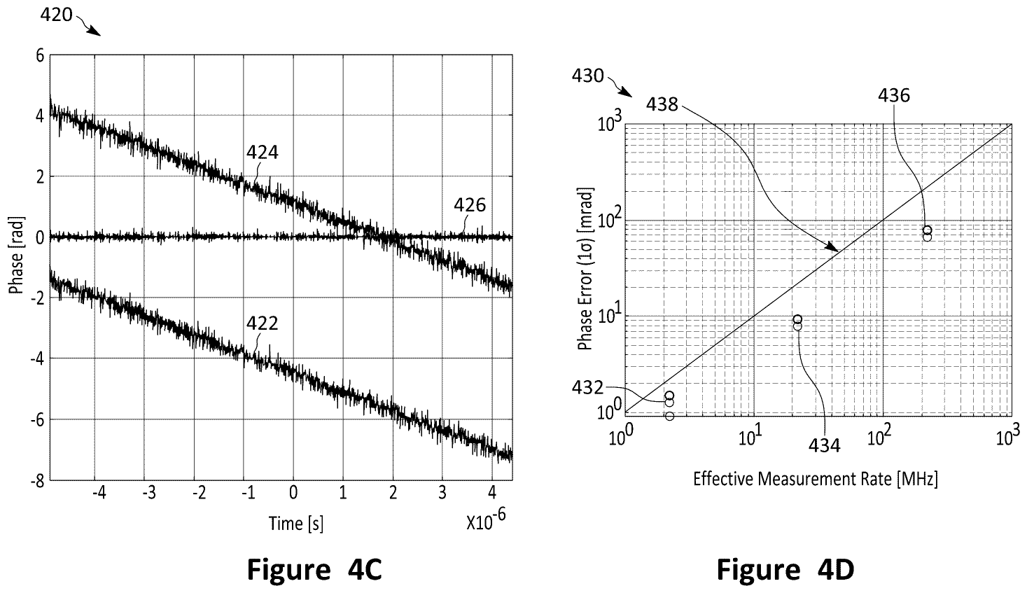

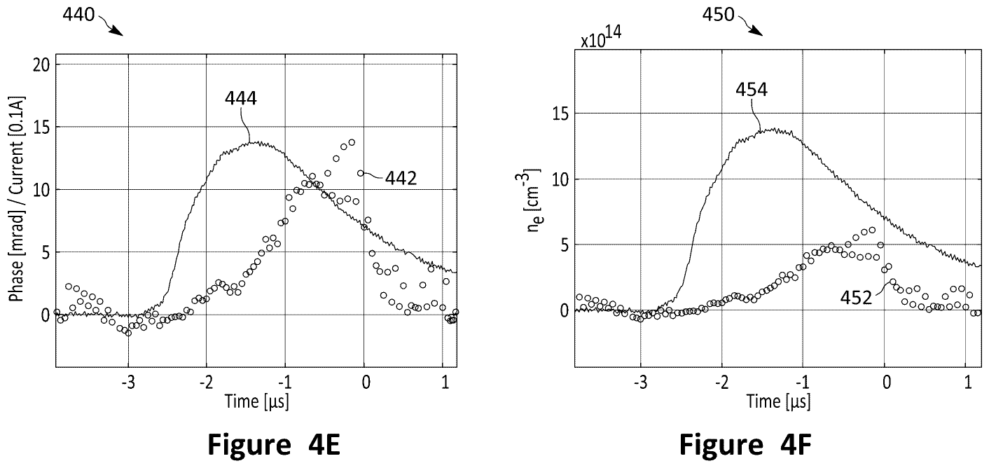

FIG. 4A is a plot 400 of an example measured heterodyne signal and reference signal 402 without plasma, in accordance with various embodiments described herein. The plot 400 may represent data acquired, for example, both on a 300 MHz bandwidth oscilloscope (e.g., sampling at 1 GS/s) and/or an FPGA-based data acquisition system. However, the plot 400 may only represent data acquired with the oscilloscope embodiment. The plot 400 more specifically indicates two digitized signals including a heterodyne signal from a photodetector (e.g., at photodiode detector 257) and a reference signal driving an acousto-optic frequency shifter (e.g., at photodiode detector 253).

FIG. 4B is a plot 410 of an example measured heterodyne signal power spectral density 412 and an example measured reference signal power spectral density 414 based on the signals of FIG. 4A, in accordance with various embodiments described herein. This plot 410 clearly illustrates the 110 MHz signal (e.g., signal point 416) in both the example measured heterodyne signal power spectral density 412 and the example measured reference signal power spectral density 414. In each case, the data indicates a broad, flat noise spectrum that scales with the heterodyne signal level. While some additional noise appears near 250 MHz, which is approximately one quarter of the digitization rate, this additional noise does not have an effect on the data as only frequency content from approximately 0-220 MHz is applied to the phase retrieval, as described herein.

FIG. 4C is a plot 420 of example phase measurements for the measured heterodyne signal 422 and the measured reference signal 424 indicated in FIG. 4B, in accordance with various embodiments described herein. Extraction of the signal phase (e.g., performed by data processing device 102) is performed using a Fourier-transform based method whereby the 110 MHz carrier is down-shifted back to zero frequency in frequency space and the signal is windowed within a +/−100 MHz rate before applying an inverse Fourier transformation.

The resulting phase traces from this phase signal extraction process are represented by the measured heterodyne signal 422 and the measured reference signal 424. Any residual drift in the measured reference signal 424 phase is generally mirrored in the measured heterodyne signal 422 phase. Moreover, any short-term fluctuations in signal generation may be removed by subtracting the heterodyne phase and the reference phase indicated in FIG. 4C. The resulting difference profile 426 (e.g., a mean-subtracted difference), exhibits excellent stability and lower fluctuation levels than either of the two original signals 422, 424. A raw difference signal may be obtained at an effective sampling rate of twice the heterodyne frequency (e.g., approximately 220 MHz), which may be a maximum limit on the phase acquisition speed.

The ultimate noise floor for electron density measurements may be determined based on equation (5). To evaluate the noise floor for different sample rates, the data processing systems described herein may down-sample measurements by a factor of ten (e.g., 22 MHz) and/or 100 (e.g., 2.2 MHz), and in each case may evaluate the standard deviation over the entire trace. The measurement systems described herein (e.g., measurement systems 200, 230) generally measure the term in brackets from equation (5) (e.g., 2φ₁-φ₂=φ). Thus, to make estimates of the measurement uncertainty, the data processing systems described herein may use the relationship,

$$δ {N}_{e} = \frac{2}{3 {r}_{e} L {λ}_{1}} δ ϕ , \qquad ( 6 )$$

where δφ is the 1-sigma uncertainty in phase, given some sampling rate, and δNₑ is the 1-sigma uncertainty in the electron density at one sample point. For example, the data processing systems described herein may use L=0.2 m and λ₁=1064 nm.

FIG. 4D is a plot 430 of phase error versus an effective measurement rate based on the example phase measurements of FIG. 4C, in accordance with various embodiments described herein. The temporal averaging described in reference to FIG. 4C generally improves the noise floor approximately as 1/N, indicating that the noise floor is not a shot-noise limit. Moreover, the phase noise power spectra may include more noise at high frequencies, which further highlights the significant benefit of down sampling (e.g., low pass filtering) the measured signals. For example, a 220 MHz effective sample rate (represented by the rings 436) yields a noise level of approximately 70-80 mrad, a 22 MHz effective sample rate (represented by the rings 434) yields an approximately 8-9 mrad noise floor, and a 2.2 MHz effective sample rate (represented by the rings 432) yields an approximately 1 mrad noise floor.

Using equation (4), the data processing components described herein may calculate the corresponding electron density detection limits, which are represented below in Table 1. In particular, Table 1 highlights the high sensitivity of the present diagnostic techniques at low measurement rates, for example, achieving a detection limit of approximately 10¹² cm⁻³ at greater than a 1 MHz sampling rate.

TABLE 1
Electron Density Detection Limits at
various Measurement Sampling Rates

| Measurement Rate | Phase Detection Limit | Electron Density |
|---|---|---|
| [MHz] | [mrad] | Detection Limit [cm⁻³] |
| 220 | 75 | 8.3 10¹³ |
| 22 | 8.5 | 9.4 10¹² |
| 2.2 | 1.5 | 1.7 10¹² |

At the upper limit of electron density, the systems described herein may only require that the rate of change in electron density be sufficiently slow as to permit Nyquist sampling of the effective frequency. To illustrate the meaning of effective frequency, we consider a phase function given by,

$$ϕ ( t ) = 2 π {f}_{0} t + 1.5 {r}_{e} L λ \frac{{dN}_{e}}{dt} t = [ 2 π {f}_{0} t + 1.5 {r}_{e} L λ \frac{{dN}_{e}}{dt} ] t \qquad ( 7 )$$

This linear phase variation may generally manifest as a sine wave at the new frequency

$${f}^{′} = {f}_{0} + \frac{3}{4 π} {r}_{e} L λ \frac{{dN}_{e}}{dt} .$$

By sampling these frequency values faster than the Nyquist limit (fₛₐₘₚ=2f′), the systems described herein can accurately measure these frequency values. If we consider a positive change of N_{e,max} over a duration Δt, then the maximum electron density given a sampling rate of fₛₐₘₚ can be expressed as,

$${N}_{e , max} = ( \frac{{f}_{samp}}{2} - {f}_{0} ) Δ t \times \frac{4 π}{3 {r}_{e} L λ} , \qquad ( 8 )$$

where these values may generally be fₛₐₘₚ=1 GHz, f₀=110 MHz. For a rise time of 1 μs, this yields a maximum electron density of approximately 2.7×10¹⁸ cm⁻³. The systems described herein can further detect a higher density by increasing the sampling rate of the data acquisition system (e.g., heterodyne detection system 104e). By contrast, if

$$\frac{{dN}_{e}}{dt}$$

is negative, the rate of change may be limited by the heterodyne frequency. For example, a 110 MHz system may have a minimum rate of approximately −7.7×10¹⁷ cm⁻³/μs.

FIG. 4E is a plot 440 of an example phase measurement (represented by the set of dots 442) synchronized with a current pulse profile 444, in accordance with various embodiments described herein. Generally, the current pulse profile 444 illustrated in FIG. 4E may be made across a 1 cm discharge gap that was sustained by energy stored in a 4.7 nanofarad (nF) capacitor assembled in parallel with the gap. The capacitor may be charged, for example, through a set of ballast resistors at constant 4 milliamps (mA), producing spark discharges when the capacitor reaches the breakdown voltage (e.g., approximately 1 kV), at an approximate rate of 0.5 Hz.

As illustrated in FIG. 4E, shortly after the start of the current pulse profile 444 the phase (e.g., indicated by the example phase measurement 442) begins to rise, reaching a peak shortly after the peak in the current pulse profile 444. Subsequently, the example phase measurement 442 drops back to nearly zero in the span of approximately 0.5 μs.

FIG. 4F is a plot 450 of an example conversion of the phase change to electron density, in accordance with various embodiments described herein. The plot 450 includes an electron density profile (represented by the set of dots 452) and a current pulse profile 454.

For the data processing systems described herein to convert the phase (e.g., 442) to the electron density profile 452, the systems generally use equation (5) and a plasma path-length value. While the plasma chamber (e.g., plasma chamber 104d) path may be known, the data processing systems described herein may also utilize image data of the plasma chamber (e.g., captured by one or more cameras, e.g., as part of the optical components 104h) to measure the plasma fluorescence and estimate the path length in pulsed discharges, which can be important due to discharge constriction and, on longer timescales, hydrodynamic expansion.

In the example plot 450 of FIG. 4F, the data processing systems may output a peak density of approximately 5×10¹⁴ cm⁻³, shortly after the discharge peak illustrated in the current pulse profile 454. In some examples, a slight delay between the electron density and the current pulse can be expected, for example, because Joule heating from the current flow acts as the energy source for ionization. Thus, the peak current flow illustrated in the current pulse profile 454 roughly corresponds with the peak rate of increase in the electron density, as illustrated in the electron density profile 452.

It should be noted that the data represented in FIGS. 4A-4F may represent the system functionality without the presence of plasma (i.e., quiescent conditions), to assess the background noise and phase stability of the diagnostic measurements.

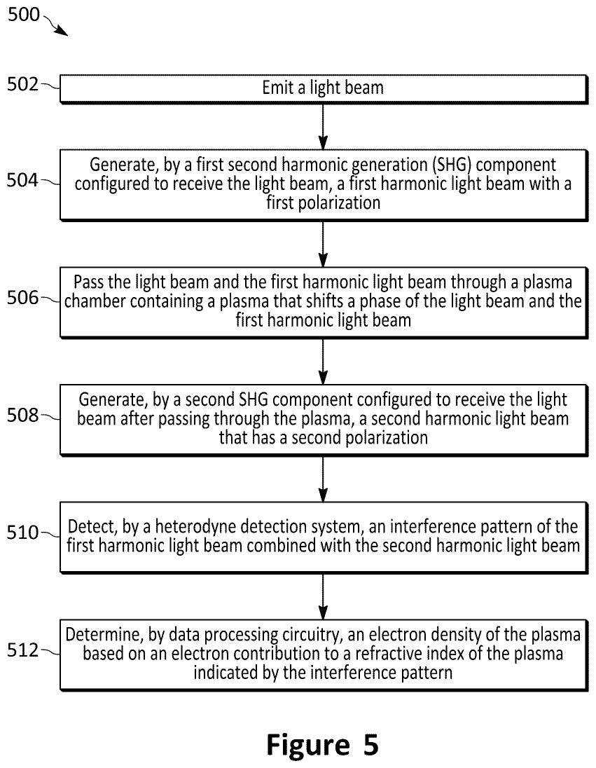

FIG. 5 depicts a flow diagram representing an example computer-implemented method 500 for measuring electron density within a plasma, in accordance with various embodiments described herein. The method 500 may be implemented by one or more processors of the example measurement system 100, such as the one or more processors 102a of the data processing device 102 (e.g., executing the interference analysis instructions 102b1), for example.

The method 500 includes emitting, by a laser source, a light beam (block 502). The method 500 further includes generating, by a first second harmonic generation (SHG) component configured to receive the light beam, a first harmonic light beam with a first polarization (block 504). The method 500 further includes passing the light beam and the first harmonic light beam through a plasma chamber containing a plasma (block 506). The interaction of the light beams with the plasma shifts a phase of the light beam and the first harmonic light beam.

The method 500 further includes generating, by a second SHG component configured to receive the light beam after passing through the plasma, a second harmonic light beam that has a second polarization (block 508). The method 500 further includes detecting, by a heterodyne detection component, an interference pattern of the first harmonic light beam combined with the second harmonic light beam (block 510). The method 500 further includes determining, by data processing circuitry, an electron density of the plasma based on an electron contribution to a refractive index of the plasma indicated by the interference pattern (block 512).

In certain embodiments, the heterodyne detection component is a fiber-based heterodyne detection component comprising a single polarization-maintaining fiber, and the method 500 further includes coupling, by the heterodyne detection component, the first harmonic light beam and the second harmonic light beam into the single polarization-maintaining fiber.

In some embodiments, the laser source, the first SHG component, the plasma chamber, and the second SHG component are arranged as a common-path, free-space optical system to minimize interferences.

In certain embodiments, the method 500 further includes shifting, by a frequency shifter, a frequency of the first harmonic light beam relative to the second harmonic light beam; and adjusting, by a wave plate, the first polarization of the first harmonic light beam.

In some embodiments, the first harmonic light beam and the second harmonic light beam co-propagate within the heterodyne detection system, and the method 500 further includes detecting, by the heterodyne detection system, the interference pattern as a self-referenced heterodyne signal encoding the electron contribution to the refractive index of the plasma, wherein the self-referenced heterodyne signal has a heterodyne frequency that is in the RF domain.

In certain embodiments, the method 500 further includes down-shifting, by the data processing circuitry, the first harmonic light beam to eliminate the frequency shift; applying, by the data processing circuitry, an inverse Fourier transform to the self-referenced heterodyne signal and a reference signal; and determining, by the data processing circuitry, a phase change of the self-referenced heterodyne signal based on the inverse Fourier transform.

In certain embodiments, the laser source, the first SHG component, the plasma chamber, the second SHG component, and the heterodyne detection component are arranged as a fiber-based system to transmit the light beam, the first harmonic light beam, and the second harmonic light beam through fiber optic cables.

In some embodiments, the first polarization is different from the second polarization. In certain embodiments, the first polarization is orthogonal to the second polarization. However, in other embodiments, the first polarization may be the same as the second polarization.

In certain embodiments, the laser source is a continuous wave laser source, the light beam is comprised of near-infrared (near IR) radiation, and the first harmonic light beam and the second harmonic light beam are comprised of visible radiation.

In some embodiments, the light beam is comprised of near IR radiation having a wavelength of approximately 1064 nanometers (nm), and the first harmonic light beam and the second harmonic light beam are comprised of visible radiation having a wavelength of approximately 532 nm.

In certain embodiments, the first SHG component and the second SHG component are nonlinear crystals. Further in these embodiments, the first SHG component is a periodically poled stoichiometric lithium tantalate (PPSLT) crystal and the second SHG component is a periodically poled lithium niobate (PPLN) crystal.

Of course, it is to be appreciated that the actions of the method 500 may be performed any suitable number of times, and that the actions described in reference to the method 500 may be performed in any suitable order.

### Examples

Example 1. A system for measuring electron density within a plasma, the system comprising: a laser source configured to emit a light beam; a first second harmonic generation (SHG) component configured to receive the light beam and generate a first harmonic light beam with a first polarization; a plasma chamber containing a plasma, wherein the light beam and the first harmonic light beam pass through the plasma chamber to shift a phase of the light beam and the first harmonic light beam; a second SHG component configured to receive the light beam after passing through the plasma chamber and generate a second harmonic light beam that has a second polarization; a heterodyne detection component configured to detect an interference pattern of the first harmonic light beam combined with the second harmonic light beam; and data processing circuitry configured to determine an electron density of the plasma based on an electron contribution to a refractive index of the plasma indicated by the interference pattern.

Example 2. The system of example 1, wherein: the heterodyne detection component is a fiber-based heterodyne detection component comprising a single polarization-maintaining fiber; and the first harmonic light beam and the second harmonic light beam are coupled into the single polarization-maintaining fiber.

Example 3. The system of example 1 or 2, wherein the laser source, the first SHG component, the plasma chamber, and the second SHG component are arranged as a common-path, free-space optical system to minimize interferences.

Example 4. The system of any of examples 1-3, further comprising: a frequency shifter configured to frequency shift the first harmonic light beam relative to the second harmonic light beam; and a wave plate configured to adjust the first polarization of the first harmonic light beam.

Example 5. The system of example 4, wherein the first harmonic light beam and the second harmonic light beam co-propagate within the heterodyne detection system, and the heterodyne detection system detects the interference pattern as a self-referenced heterodyne signal encoding the electron contribution to the refractive index of the plasma.

Example 6. The system of example 5, wherein the self-referenced heterodyne signal has a heterodyne frequency that is in a radio frequency (RF) domain.

Example 7. The system of example 5 or 6, wherein the data processing circuitry is further configured to: down-shift the first harmonic light beam to eliminate the frequency shift; apply an inverse Fourier transform to the self-referenced heterodyne signal and a reference signal; and determine a phase change of the self-referenced heterodyne signal based on the inverse Fourier transform.

Example 8. The system of any of examples 1-7, wherein the laser source, the first SHG component, the plasma chamber, the second SHG component, and the heterodyne detection component are arranged as a fiber-based system to transmit the light beam, the first harmonic light beam, and the second harmonic light beam through fiber optic cables.

Example 9. The system of any of examples 1-8, wherein the first polarization is orthogonal to the second polarization.

Example 10. The system of any of examples 1-9, wherein the laser source is a continuous wave laser source, the light beam is comprised of near-infrared (near IR) radiation, and the first harmonic light beam and the second harmonic light beam are comprised of visible radiation.

Example 11. The system of example 10, wherein the light beam is comprised of near IR radiation having a wavelength of approximately 1064 nanometers (nm), and the first harmonic light beam and the second harmonic light beam are comprised of visible radiation having a wavelength of approximately 532 nm.

Example 12. The system of any of examples 1-11, wherein the first SHG component and the second SHG component are nonlinear crystals.

Example 13. The system of example 12, wherein the first SHG component is a periodically poled stoichiometric lithium tantalate (PPSLT) crystal and the second SHG component is a periodically poled lithium niobate (PPLN) crystal.

Example 14. The system of any of examples 1-13, wherein the laser source is a first laser source, and the system further comprises: a second laser source configured to emit a laser pulse through a portion of the plasma chamber, the laser pulse configured to generate a shockwave propagating through the plasma that simulates a change in the electron density of the plasma.

Example 15. A method for measuring electron density within a plasma, the method comprising: emitting, by a laser source, a light beam; generating, by a first second harmonic generation (SHG) component configured to receive the light beam, a first harmonic light beam with a first polarization; passing the light beam and the first harmonic light beam through a plasma chamber containing a plasma to shift a phase of the light beam and the first harmonic light beam; generating, by a second SHG component configured to receive the light beam after passing through the plasma chamber, a second harmonic light beam that has a second polarization; detecting, by a heterodyne detection component, an interference pattern of the first harmonic light beam combined with the second harmonic light beam; and determining, by data processing circuitry, an electron density of the plasma based on an electron contribution to a refractive index of the plasma indicated by the interference pattern.

Example 16. The method of example 15, wherein the heterodyne detection component is a fiber-based heterodyne detection component comprising a single polarization-maintaining fiber, and the method further comprises: coupling, by the heterodyne detection component, the first harmonic light beam and the second harmonic light beam into the single polarization-maintaining fiber.

Example 17. The method of example 15 or 16, wherein the laser source, the first SHG component, the plasma chamber, and the second SHG component are arranged as a common-path, free-space optical system to minimize interferences.

Example 18. The method of any of examples 15-17, further comprising: shifting, by a frequency shifter, a frequency of the first harmonic light beam relative to the second harmonic light beam; and adjusting, by a wave plate, the first polarization of the first harmonic light beam.

Example 19. The method of example 18, wherein the first harmonic light beam and the second harmonic light beam co-propagate within the heterodyne detection system, and the method further comprises: detecting, by the heterodyne detection system, the interference pattern as a self-referenced heterodyne signal encoding the electron contribution to the refractive index of the plasma, wherein the self-referenced heterodyne signal has a heterodyne frequency that is in a radio frequency (RF) domain.

Example 20. A non-transitory, computer-readable medium comprising instructions that, when executed by one or more processors, cause the one or more processors to: receive, from a heterodyne detection component, data indicating an interference pattern associated with a first harmonic light beam having a first polarization and a second harmonic light beam having a second polarization, the first harmonic light beam being generated by a light beam passing through a first second harmonic generation (SHG) component, the second harmonic light beam being generated by the light beam passing through a second SHG component after passing through a plasma chamber to shift a phase of the light beam; and determining an electron density of the plasma based on an electron contribution to a refractive index of the plasma indicated by the interference pattern.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “one aspect,” “an aspect,” or “an embodiment” means that a particular element, feature, structure, or characteristic described in connection with the embodiment is included in at least one embodiment/aspect. The appearances of the phrase “in one embodiment” or “in one aspect” in various places in the specification are not necessarily all referring to the same embodiment/aspect.

Some embodiments/aspects may be described using the expression “coupled” and “connected” along with their derivatives. For example, some embodiments/aspects may be described using the term “coupled” to indicate that two or more elements are in direct physical or electrical contact. The term “coupled,” however, may also mean that two or more elements are not in direct contact with each other, but yet still co-operate or interact with each other. The embodiments/aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments/aspects herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments/aspects without departing from the spirit and scope of the invention.

The foregoing description is given for clearness of understanding; and no unnecessary limitations should be understood therefrom, as modifications within the scope of the invention may be apparent to those having ordinary skill in the art.

What is claimed is:

1. A system for measuring electron density within a plasma, the system comprising:
a laser source configured to emit a light beam;
a first second harmonic generation (SHG) component configured to receive the light beam and generate a first harmonic light beam with a first polarization;
a plasma chamber containing a plasma, wherein the light beam and the first harmonic light beam pass through the plasma chamber to shift a phase of the light beam and the first harmonic light beam;
a second SHG component configured to receive the light beam after passing through the plasma chamber and generate a second harmonic light beam that has a second polarization;
a heterodyne detection component configured to detect an interference pattern of the first harmonic light beam combined with the second harmonic light beam; and
data processing circuitry configured to determine an electron density of the plasma based on an electron contribution to a refractive index of the plasma indicated by the interference pattern.

2. The system of claim 1, wherein:
the heterodyne detection component is a fiber-based heterodyne detection component comprising a single polarization-maintaining fiber; and
the first harmonic light beam and the second harmonic light beam are coupled into the single polarization-maintaining fiber.

3. The system of claim 1, wherein the laser source, the first SHG component, the plasma chamber, and the second SHG component are arranged as a common-path, free-space optical system to minimize interferences.

4. The system of claim 1, further comprising:
a frequency shifter configured to frequency shift the first harmonic light beam relative to the second harmonic light beam; and
a wave plate configured to adjust the first polarization of the first harmonic light beam.

5. The system of claim 1, wherein the first harmonic light beam and the second harmonic light beam co-propagate within the heterodyne detection system, and the heterodyne detection system detects the interference pattern as a self-referenced heterodyne signal encoding the electron contribution to the refractive index of the plasma.

6. The system of claim 5, wherein the self-referenced heterodyne signal has a heterodyne frequency that is in a radio frequency (RF) domain.

7. The system of claim 5, wherein the data processing circuitry is further configured to:
down-shift the first harmonic light beam to eliminate a frequency shift of the first harmonic light beam;
apply an inverse Fourier transform to the self-referenced heterodyne signal and a reference signal; and
determine a phase change of the self-referenced heterodyne signal based on the inverse Fourier transform.

8. The system of claim 1, wherein the laser source, the first SHG component, the plasma chamber, the second SHG component, and the heterodyne detection component are arranged as a fiber-based system to transmit the light beam, the first harmonic light beam, and the second harmonic light beam through fiber optic cables.

9. The system of claim 1, wherein the first polarization is orthogonal to the second polarization.

10. The system of claim 1, wherein the laser source is a continuous wave laser source, the light beam is comprised of near-infrared (near IR) radiation, and the first harmonic light beam and the second harmonic light beam are comprised of visible radiation.

11. The system of claim 10, wherein the light beam is comprised of near IR radiation having a wavelength of approximately 1064 nanometers (nm), and the first harmonic light beam and the second harmonic light beam are comprised of visible radiation having a wavelength of approximately 532 nm.

12. The system of claim 1, wherein the first SHG component and the second SHG component are nonlinear crystals.

13. The system of claim 12, wherein the first SHG component is a periodically poled stoichiometric lithium tantalate (PPSLT) crystal and the second SHG component is a periodically poled lithium niobate (PPLN) crystal.

14. The system of claim 1, wherein the laser source is a first laser source, and the system further comprises:
a second laser source configured to emit a laser pulse through a portion of the plasma chamber, the laser pulse configured to generate a shockwave propagating through the plasma that simulates a change in the electron density of the plasma.

15. A method for measuring electron density within a plasma, the method comprising:
emitting, by a laser source, a light beam;
generating, by a first second harmonic generation (SHG) component configured to receive the light beam, a first harmonic light beam with a first polarization;
passing the light beam and the first harmonic light beam through a plasma chamber containing a plasma to shift a phase of the light beam and the first harmonic light beam;
generating, by a second SHG component configured to receive the light beam after passing through the plasma chamber, a second harmonic light beam that has a second polarization;
detecting, by a heterodyne detection component, an interference pattern of the first harmonic light beam combined with the second harmonic light beam; and
determining, by data processing circuitry, an electron density of the plasma based on an electron contribution to a refractive index of the plasma indicated by the interference pattern.

16. The method of claim 15, wherein the heterodyne detection component is a fiber-based heterodyne detection component comprising a single polarization-maintaining fiber, and the method further comprises:
coupling, by the heterodyne detection component, the first harmonic light beam and the second harmonic light beam into the single polarization-maintaining fiber.

17. The method of claim 15, wherein the laser source, the first SHG component, the plasma chamber, and the second SHG component are arranged as a common-path, free-space optical system to minimize interferences.

18. The method of claim 15, further comprising:
shifting, by a frequency shifter, a frequency of the first harmonic light beam relative to the second harmonic light beam; and
adjusting, by a wave plate, the first polarization of the first harmonic light beam.

19. The method of claim 15, wherein the first harmonic light beam and the second harmonic light beam co-propagate within the heterodyne detection system, and the method further comprises:
detecting, by the heterodyne detection system, the interference pattern as a self-referenced heterodyne signal encoding the electron contribution to the refractive index of the plasma, wherein the self-referenced heterodyne signal has a heterodyne frequency that is in a radio frequency (RF) domain.

20. A non-transitory, computer-readable medium comprising instructions that, when executed by one or more processors, cause the one or more processors to:
receive, from a heterodyne detection component, data indicating an interference pattern associated with a first harmonic light beam having a first polarization and a second harmonic light beam having a second polarization, the first harmonic light beam being generated by a light beam passing through a first second harmonic generation (SHG) component, the second harmonic light beam being generated by the light beam passing through a second SHG component after passing through a plasma chamber to shift a phase of the light beam; and
determining an electron density of the plasma based on an electron contribution to a refractive index of the plasma indicated by the interference pattern.
